(19) United States
(12) Patent Application Publication
(10) Pub. No.: US 2025/0140286 A1
(43) Pub. Date: May 1, 2025

(54) HARD DISK DRIVE INTERPOSE SWAGE

(71) Applicant: Western Digital Technologies, Inc., San Jose, CA (US)

(72) Inventors: Toshihisa Okazaki, Odawara (JP); Andrew Hanlon, San Jose, CA (US)

(21) Appl. No.: 18/383,836

(22) Filed: Oct. 25, 2023

(51) Int. Cl. G11B 5/48

(52) U.S. Cl. CPC G11B 5/4826

(57) ABSTRACT

A head gimbal assembly (HGA) for a hard disk drive includes a carriage arm having a swaging hole, first and second suspensions, and respective first and second swage plates to which the first and second suspensions are respectively coupled. Each swage plate includes a respective series of intermittent swage boss structures extending from a baseplate, where the swage boss structures of each swage plate are relatively positioned, extending from a respective side of the arm into the swaging hole, such each of the one series of swage boss structures interposes with the other series of swage boss structures. With both series of interposed swage boss structures occupying the same swaging hole height, the height of each swage boss can be effectively doubled and a higher retention torque of the swage coupling is enabled even in view of a thinner arm tip and shorter corresponding swaging hole.

### FIELD OF EMBODIMENTS

Embodiments of the invention may relate generally to hard disk drives, and particularly to approaches to an interposing swage boss.

### BACKGROUND

A hard disk drive (HDD) is a non-volatile storage device that is housed in a protective enclosure and stores digitally encoded data on one or more circular disks having magnetic surfaces. When an HDD is in operation, each magnetic-recording disk is rapidly rotated by a spindle system. Data is read from and written to a magnetic-recording disk using a read-write head (or “transducer”) that is positioned over a specific location of a disk by an actuator. A read-write head makes use of magnetic fields to write data to and read data from the surface of a magnetic-recording disk. A write head works by using the current flowing through its coil to produce a magnetic field. Electrical pulses are sent to the write head, with different patterns of positive and negative currents. The current in the coil of the write head produces a localized magnetic field across the gap between the head and the magnetic disk, which in turn magnetizes a small area on the recording medium.

An HDD includes at least one head gimbal assembly (HGA) that generally includes a slider that houses the read-write transducer (or “read-write head”) and a suspension. Each slider is attached to the free end of a suspension that in turn is cantilevered from the rigid arm of an actuator. Several actuator arms may be combined to form a single movable unit, a head stack assembly (HSA), typically having a rotary pivotal bearing system. The suspension of a conventional HDD typically includes a relatively stiff load beam with a mount plate at its base end, which attaches to the actuator arm, and whose free end mounts a flexure that carries the slider and its read-write head. Positioned between the mount plate and the functional end of the load beam is a “hinge” that is compliant in the vertical bending direction (normal to the disk surface). The hinge enables the load beam to suspend and load the slider and the read-write head toward the spinning disk surface. It is then the function of the flexure to provide gimbaled support for the slider so that the slider can pitch and roll in order to adjust its orientation.

Any approaches that may be described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

Embodiments are illustrated by way of example, and not by way of limitation, in the figures of the accompanying drawings and in which like reference numerals refer to similar elements and in which:

FIG. 1 is a plan view illustrating a hard disk drive, according to an embodiment;

FIG. 2A is a perspective view illustrating a swage plate;

FIG. 2B is a cross-sectional side view illustrating a swaged suspension-arm assembly utilizing the swage plate of FIG. 2A;

FIG. 3 is an exploded perspective diagram illustrating a conventional swage boss;

FIG. 4A is an exploded perspective diagram illustrating an example interpose swage boss, according to an embodiment;

FIG. 4B is an exploded perspective diagram illustrating another example interpose swage boss, according to an embodiment; and

FIG. 5 is a flow diagram illustrating a method of assembling a head gimbal assembly, according to an embodiment.

### DETAILED DESCRIPTION

Generally, approaches to enabling a thin carriage arm tip by employing an interposeing swage boss in a hard disk drive (HDD), are described. In the following description, for the purposes of explanation, numerous specific details are set forth in order to provide a thorough understanding of the embodiments of the invention described herein. It will be apparent, however, that the embodiments of the invention described herein may be practiced without these specific details. In other instances, well-known structures and devices may be shown in block diagram form in order to avoid unnecessarily obscuring the embodiments of the invention described herein.

### Introduction

### Terminology

References herein to “an embodiment”, “one embodiment”, and the like, are intended to mean that the particular feature, structure, or characteristic being described is included in at least one embodiment of the invention. However, instances of such phrases do not necessarily all refer to the same embodiment,

The term “substantially” will be understood to describe a feature that is largely or nearly structured, configured, dimensioned, etc., but with which manufacturing tolerances and the like may in practice result in a situation in which the structure, configuration, dimension, etc. is not always or necessarily precisely as stated. For example, describing a structure as “substantially vertical” would assign that term its plain meaning, such that the sidewall is vertical for all practical purposes but may not be precisely at 90 degrees throughout.

While terms such as “optimal”, “optimize”, “minimal”, “minimize”, “maximal”, “maximize”, and the like may not have certain values associated therewith, if such terms are used herein the intent is that one of ordinary skill in the art would understand such terms to include affecting a value, parameter, metric, and the like in a beneficial direction consistent with the totality of this disclosure. For example, describing a value of something as “minimal” does not require that the value actually be equal to some theoretical minimum (e.g., zero), but should be understood in a practical sense in that a corresponding goal would be to move the value in a beneficial direction toward a theoretical minimum.

### Context

Increasing the storage capacity of hard disk drives (HDDs) is one of the on-going goals of HDD technology evolution. In one form, this goal manifests in increasing the number of disks implemented in a given HDD. However, oftentimes the customer demand requires maintaining a standard form factor, as characterized in part by the z-height of an HDD. This inherently provides challenges with respect to fitting more disks into a given HDD, such as by necessitating high-density mechanical structure in the z-height direction with respect to the head gimbal assembly (HGA) interposed between adjacent disks. More particularly, customer specifications and/or common design and operational constraints include operational shock (or “op-shock”) requirements, which generally relate to an HDD's operational resistance to or operational tolerance of a mechanical shock event. Recall that the suspension of an HDD typically includes a relatively stiff load beam with a mount plate at its base end, which attaches to the actuator arm, and whose free end mounts a flexure that carries the slider and its read-write head. Thus, it remains a challenge to increase the number of disks while maintaining a standard form factor, which decreases the distance between each disk of the disk stack, while also reliably meeting op-shock requirements. In particular, the limited mechanical clearances associated with the HGA, such as relative to the operational positioning of each suspension as interposed with the disks within the disk stack, pose a challenge to meeting such requirements. Stated otherwise, the less spacing between disks may logically result in lower op-shock performance in the context of a typically configured HGA.

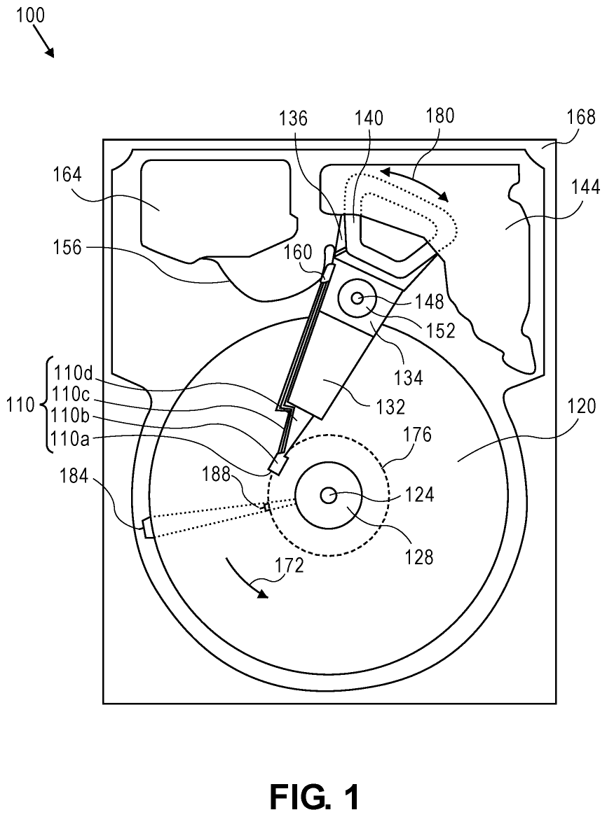

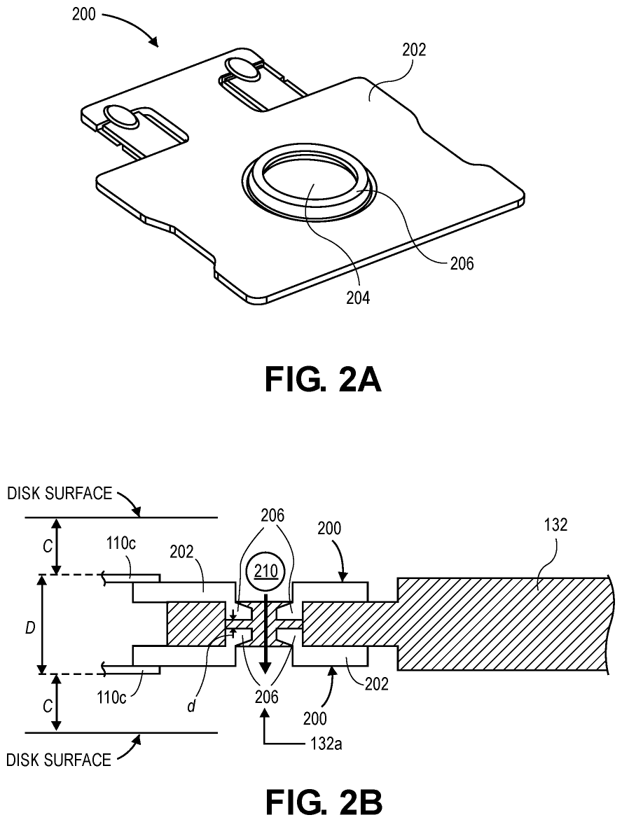

FIG. 2A is a perspective view illustrating a swage plate, and FIG. 2B is a cross-sectional side view illustrating a swaged suspension-arm assembly utilizing the swage plate of FIG. 2A. Swage plate 200 illustrates what may be considered a typical swage plate used for coupling an HDD suspension to a corresponding actuator arm. Swage plate 200 comprises a main body 202 comprising a swage through-hole 204 therethrough, which is surrounded at its perimeter by a swage boss 206. Typically, the swage plate 200 would have a suspension (such as lead suspension 110c of FIG. 1) welded or otherwise mechanically coupled thereto (as well as electrically coupled thereto), prior to the swaging (or swage-coupling) of the suspension to a corresponding actuator arm (such as arm 132 of FIG. 1, or “carriage arm 132”). Swaging is a well-known forging process typically enacted by forcing a swage ball 210 through the through-hole 204 to deform or alter the dimensions of the swage boss 206 (e.g., rotary swaging), to cold work the metals to form a bond or inter-coupling of the swage plate 200/suspension 110c subcomponent and the actuator arm 132 subcomponent. That is, the swage boss 206 is inserted into an aperture 132a (or “swaging hole 132a”) in the actuator arm 132 and a swage ball 210, which has a larger diameter than the inner diameter of the swage boss 206, is inserted into the swage through-hole 204 of the swage boss 206 to swage couple the swage boss 206 to the aperture 132a by applying a compressive force to the inner surface of the swage boss 206 such that the swage boss 206 expands to hold the actuator arm 132 to the suspension 110c.

As can be appreciated by the illustration of FIG. 2B, the distance (D) from the outer surface of the “up” suspension (e.g., the upper suspension 110c housing an “up” (UP) head which interacts with the lower surface of a corresponding above disk) and the “down” suspension (e.g., the lower suspension 110c housing a “down” (DN) head which interacts with the upper surface of a corresponding below disk) is a driving dimension in regards to the amount of dimensional clearance (C) afforded between each suspension 110c and a corresponding disk surface on which the corresponding read-write transducer operates. This clearance C, therefore, would affect the likelihood that either of the HGAs (or constituent subcomponents) might mechanically interact with (e.g., “hit”) its corresponding disk surface consequent to a shock event, which could likewise affect the overall op-shock performance of the HDD. In view of the foregoing and the goal of increasing the number of recording disks in a disk stack, an approach to reducing the distance D between the pair of suspensions swaged to a given actuator arm, while maintaining the necessary clearance C with corresponding disk surfaces, may be desirable.

Approaches to the foregoing space issue may include, for example, reducing the arm tip thickness within the constraint allowed by the swage boss buildup, reducing the overall thickness of the stamped swage plate part (but this could likely lead to easy bending due to the lower yield strength post-annealing), and reducing the thickness of the media to allow greater clearance between the media and arm mounting surfaces.

### Interpose Swage Boss Enabling Thinner Carriage Arm Tip

As alluded to, currently the common approach to HGA assembly involves swaging, whereby both UP/DN heads are swaged at the same hole of the carriage arm (or “actuator arm” or simply “arm”), except for with end arms and corresponding heads. However, with the drive to increasing HDD storage capacity by incorporating more disks therein, the arm tip thickness is trending thinner and thus the swage boss height is trending lower. This likely results in a lower retention torque of the swage coupling, and also presents difficulties with manufacturing.

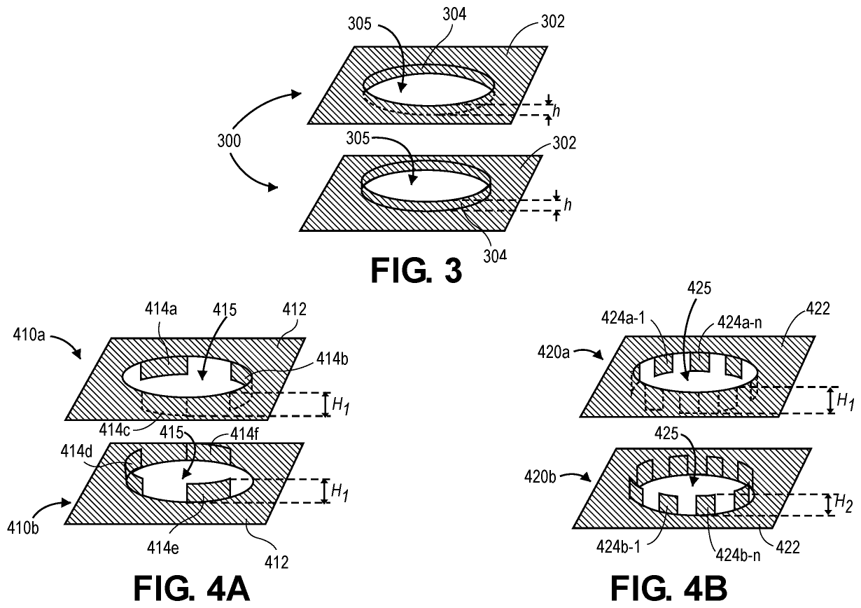

FIG. 3 is an exploded perspective diagram illustrating a conventional swage boss. Each swage plate 300 comprises a baseplate 302 and a swage boss 304 that extends from the baseplate 302 around a through-hole 305. As assembled, the swage boss 304 of the lower swage plate 300 (for DN head) would extend upward into a corresponding swaging hole (see, e.g., swaging hole 132a of FIG. 2B) of an arm 132 (see, e.g., arm 132 of FIGS. 1, 2B) while the swage boss 304 of the upper swage plate 300 (for UP head) would extend downward into the corresponding swaging hole 132a of the arm 132. Because of the trend toward a thinner arm 132 tip, i.e., the portion comprising the swaging hole 132a by which a corresponding suspension (see, e.g., lead suspension 110c of FIG. 1, 2B) is swaged to the arm 132 via a swage plate 300, the trend toward a shorter swage boss 304 results. That is, because each swage boss 304 occupies a portion of the swaging hole 132a height, the height h of each swage boss 304 is limited by the thickness of the arm 132 tip and thus the equivalent height (e.g., approximately 2h) of the swaging hole 132a of the arm 132.

FIG. 4A is an exploded perspective diagram illustrating an example interpose swage boss, according to an embodiment. A first swage plate 410a (for UP head) of this embodiment comprises a baseplate 412 and a first series of intermittent swage boss structures 414a, 414b, 414c, for example, extending from the baseplate 412 around a through-hole 415 and separated by slots. Similarly, a second swage plate 410b (for DN head) of this embodiment comprises a baseplate 412 and a second series of intermittent swage boss structures 414d, 414e, 414f, for example, extending from the baseplate 412 around a through-hole 415 and separated by slots. Note that the number of swage boss structures (e.g., 412a-412c and 412d-412f) corresponding to each respective first and second series of intermittent swage boss structures of each swage plate 412a, 412b may vary from implementation to implementation, with three each (412a-412c for 410a and 412d-412f for 410b) illustrated here for purposes of example.

As assembled, each of the first series of intermittent swage boss structures 414a, 414b, 414c of the upper swage plate 410a would extend downward from a first side of a carriage arm 132 (see, e.g., arm 132 of FIGS. 1, 2B) into a corresponding swaging hole (see, e.g., swaging hole 132a of FIG. 2B) of the carriage arm 132, while each of the second series of intermittent swage boss structures 414d, 414e, 414f of the lower swage plate 410b (for DN head) would extend upward from a second side of carriage arm 132 into the corresponding swaging hole 132a. According to an embodiment, each intermittent swage boss structure of the first series of intermittent swage boss structures 414a, 414b, 414c is positioned between adjacent intermittent swage boss structures of the second series of intermittent swage boss structures 414d, 414e, 414f, i.e., within corresponding slots of the other series. The respective swage boss structures of swage plate 410a and swage plate 410b are considered “interlocked” as the respective swage boss structures are clocked, keyed to interlock, interpose with each other. As such, the first swage plate 410a couples a first suspension assembly (see, e.g., lead suspension 110c of FIG. 1) to a first side of a carriage arm 132 via the first series of intermittent swage boss structures 414a, 414b, 414c extending in one direction into the swaging hole 132a of the carriage arm 132, and the second swage plate 410b couples a second suspension assembly (see, e.g., lead suspension 110c of FIG. 1) to a second opposing side of the carriage arm 132 via the second series of intermittent swage boss structures 414d, 414e, 414f extending in an opposing direction into a swaging hole 132a of the carriage arm 132, such that the respective first and second series of intermittent swage boss structures 414a-414c, 414d-414f do not interfere with each other.

Here, because both the first series and the second series of interposed intermittent swage boss structures 414a-414c, 414d-414f effectively occupy the same swaging hole 132a height, the height H₁ of each swage boss 414a-414f can be effectively approximately doubled from the height h of FIG. 3, e.g., H₁ approximately=2h. Thus, a higher retention torque of the swage coupling is enabled in comparison with the configuration of swage plate 300 of FIG. 3, even in view of a thinner arm tip and shorter corresponding swaging hole. Note that the height h of the swage boss 304 of swage plate 300 of FIG. 3 and the height H₁ of each swage boss 414a-414f of FIG. 4A are not intended to be drawn precisely to scale, but are drawn to portray the general sense of a doubling in height/size. According to an embodiment, the height of the swage boss structures of the first series of intermittent swage boss structures 414a-414c extending in one direction into the swaging hole 132a of the carriage arm 132, is substantially equal to a height of the swage boss structures of the second series of intermittent swage boss structures 414d-414f extending in an opposing direction into the swaging hole 132a of the arm 132.

Other variations are considered, according to an embodiment, the swage boss structures of the first series of intermittent swage boss structures 414a-414c and the swage boss structures of the second series of intermittent swage boss structures 414d-414f are equidistant and, according to an alternative embodiment, the swage boss structures of the first series of intermittent swage boss structures 414a-414c, 414d-414f are not equidistant. Furthermore and according to an embodiment, each of the swage boss structures of the first series of intermittent swage boss structures 414a-414c and/or each of the swage boss structures of the second series of intermittent swage boss structures 414d-414f is of substantially equal circumferential span and, according to an alternative embodiment, each of the swage boss structures of the first series of intermittent swage boss structures 414a-414c and/or each of the swage boss structures of the second series of intermittent swage boss structures 414d-414f is of substantially unequal circumferential span. Thus, swage plates 410a, 410b can be optimized for a particular design scenario based, for example, on mechanical configurations and constraints, loads, design goals, and the like.

As mentioned, the number of swage boss structures (e.g., 412a-412c and 412d-412f) corresponding to each respective first and second series of intermittent swage boss structures of each swage plate 412a, 412b may vary from implementation to implementation based, for example, on mechanical configurations and constraints, loads, design goals, and the like. FIG. 4B is an exploded perspective diagram illustrating another example interpose swage boss, according to an embodiment. A first swage plate 420a (for UP head) of this embodiment comprises a baseplate 422 and a first series of intermittent swage boss structures 424a-1 through 424a-n separated by slots, where n represents an arbitrary number of intermittent swage boss structures (here, eight) that may vary from implementation to implementation, extending from the baseplate 422 around a through-hole 425. Similarly, a second swage plate 420b (for DN head) of this embodiment comprises a baseplate 422 and a second series of intermittent swage boss structures 424b-1 through 424b-n separated by slots, extending from the baseplate 422 around a through-hole 425.

As assembled, each of the first series of intermittent swage boss structures 424a-1 through 424a-n of the upper swage plate 420a would extend downward from a first side of a carriage arm 132 (see, e.g., arm 132 of FIGS. 1, 2B) into a corresponding swaging hole (see, e.g., swaging hole 132a of FIG. 2B) of the carriage arm 132, while each of the second series of intermittent swage boss structures 424b-1 through 424b-n of the lower swage plate 420b (for DN head) would extend upward from a second side of carriage arm 132 into the corresponding swaging hole 132a. According to an embodiment, here too each intermittent swage boss structure of the first series of intermittent swage boss structures 424a-1 through 424a-n is positioned between adjacent intermittent swage boss structures of the second series of intermittent swage boss structures 424b-1 through 424b-n, i.e., within corresponding slots of the other series. The respective swage boss structures of swage plate 420a and swage plate 420b are considered interposed or “interlocked”. As such, the first swage plate 420a couples a first suspension assembly (see, e.g., lead suspension 110c of FIG. 1) to a first side of a carriage arm 132 via the first series of intermittent swage boss structures 424a-1 through 424a-n extending in one direction into the swaging hole 132a of the carriage arm 132, and the second swage plate 420b couples a second suspension assembly (see, e.g., lead suspension 110c of FIG. 1) to a second opposing side of the carriage arm 132 via the second series of intermittent swage boss structures 424b-1 through 424b-n extending in an opposing direction into a swaging hole 132a of the carriage arm 132, such that the respective first and second series of intermittent swage boss structures 424a-1 through 424a-n and 424b-1 through 424b-n do not interfere with each other.

Here also, because both the first series and the second series of interposed intermittent swage boss structures 424a-1 through 424a-n, 424b-1 through 424b-n effectively occupy the same swaging hole 132a height, the height H₂ of each swage boss 424a-1 through 424b-n can be effectively approximately doubled from the height h of FIG. 3, e.g., H₂ approximately=2h. Thus, a higher retention torque of the swage coupling is enabled in comparison with the configuration of swage plate 300 of FIG. 3, even in view of a thinner arm tip and shorter corresponding swaging hole. Note that the height h of the swage boss 304 of swage plate 300 of FIG. 3 and the height H₂ of each swage boss 424a-1 through 424b-n of FIG. 4B are not intended to be drawn precisely to scale, but are drawn to portray the general sense of a doubling in height/size. According to an embodiment, the height of the swage boss structures of the first series of intermittent swage boss structures 424a-1 through 424a-n extending in one direction into the swaging hole 132a of the carriage arm 132, is substantially equal to a height of the swage boss structures of the second series of intermittent swage boss structures 424b-1 through 424b-n extending in an opposing direction into the swaging hole 132a of the arm 132.

As with the example embodiments of FIG. 4A, here also if reference to FIG. 4B and according to an embodiment, the swage boss structures of the first series of intermittent swage boss structures 424a-1 through 424b-n and the swage boss structures of the second series of intermittent swage boss structures 424b-1 through 424b-n are equidistant and, according to an alternative embodiment, the swage boss structures of the first series of intermittent swage boss structures 424a-1 through 424b-n, 424b-1 through 424b-n are not equidistant. Furthermore and according to an embodiment, each of the swage boss structures of the first series of intermittent swage boss structures 424a-1 through 424b-n and/or each of the swage boss structures of the second series of intermittent swage boss structures 424b-1 through 424b-n is of substantially equal circumferential span and, according to an alternative embodiment, each of the swage boss structures of the first series of intermittent swage boss structures 424a-1 through 424b-n and/or each of the swage boss structures of the second series of intermittent swage boss structures 424b-1 through 424b-n is of substantially unequal circumferential span. Thus, swage plates 420a, 420b can also be optimized for a particular design scenario based, for example, on mechanical configurations and constraints, loads, design goals, and the like.

### Method of Assembling a Head Gimbal Assembly

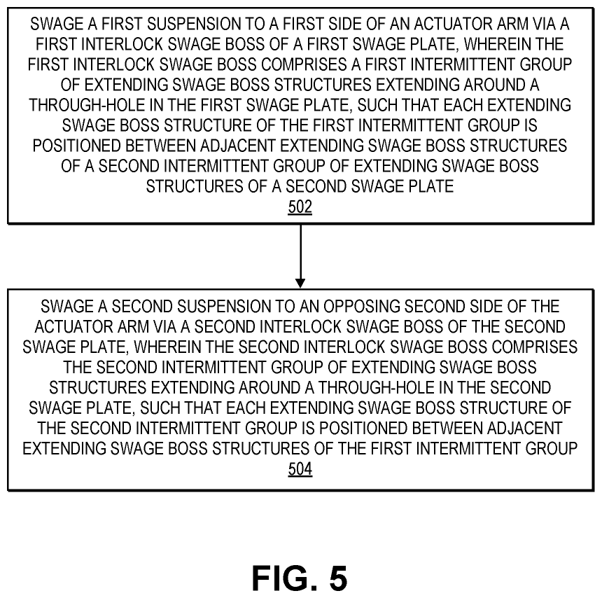

FIG. 5 is a flow diagram illustrating a method of assembling a head gimbal assembly, according to an embodiment. A head gimbal assembly (HGA) assembled, manufactured, produced according to the method of FIG. 5 is designed, configured, intended for implementation into a hard disk drive (HDD) (see, e.g., FIG. 1).

At block 502, swage a first suspension to a first side of an actuator arm via a first interpose swage boss of a first swage plate, wherein the first interpose swage boss comprises a first intermittent group of extending swage boss structures extending around a through-hole in the first swage plate. For example, first suspension (see, e.g., lead suspension 110c of FIG. 1) is swaged to a first side of an actuator arm (see, e.g., arm 132 of FIG. 1) via a first interpose swage boss of a first swage plate 410a (FIG. 4A), 420a (FIG. 4B), where the first interpose swage boss comprises a first intermittent group of extending swage boss structures 414a, 414b, 414c (FIG. 4A), 424a-1 through 424a-n (FIG. 4B) extending around a through-hole 415 (FIG. 4A), 425 (FIG. 4B) in the first swage plate 410a, 420a. According to an embodiment, the first suspension 110a is swaged to the first side of the actuator arm 132 such that each extending swage boss structure 414a, 414b, 414c, 424a-1 through 424a-n of the first intermittent group 414a-414c, 424a-1 through 424a-n is positioned between adjacent extending swage boss structures of a second intermittent group 414d-414f (FIG. 4A), 424b-1 through 424b-n (FIG. 4B).

At block 504, swage a second suspension to an opposing second side of the actuator arm via a second interpose swage boss of a second swage plate, where the second interpose swage boss comprises a second intermittent group of extending swage boss structures extending around a through-hole in the second swage plate. For example, second suspension (see, e.g., lead suspension 110c of FIG. 1) is swaged to an opposing second side of the actuator arm 132 via a second interpose swage boss of a second swage plate 410b (FIG. 4A), 420b (FIG. 4B), where the second interpose swage boss comprises a second intermittent group of extending swage boss structures 414d, 414e, 414f (FIG. 4A), 424b-1 through 424b-n (FIG. 4B) extending around a through-hole 415 (FIG. 4A), 425 (FIG. 4B) in the second swage plate 410b, 420b. Likewise, and according to an embodiment, the second suspension 110a is swaged to the second side of the actuator arm 132 such that each extending swage boss structure 414d, 414e, 414f, 424b-1 through 424b-n of the second intermittent group 414d-414f, 424b-1 through 424b-n is positioned between adjacent extending swage boss structures of the first intermittent group 414a-414c, 424a-1 through 424a-n.

A result of performing blocks 502-504 is that swaging the first suspension (block 502) includes swaging the first intermittent group of extending swage boss structures 414a-414c, 424a-1 through 424a-n extending in one direction (e.g., downward) from the first side (e.g., upper side) of the actuator arm 132 into the swaging hole 132a (see, e.g., FIG. 2B) of the actuator arm 132, and swaging the second suspension (block 504) includes swaging the second intermittent group of extending swage boss structures 414d-414f, 424b-1 through 424b-n extending in an opposing direction (e.g., upward) from the second side (e.g., lower side) into the swaging hole 132a of the actuator arm 132, such that the second intermittent group 414d-414f, 424b-1 through 424b-n does not substantially interfere (e.g., mechanically, structurally) with the first intermittent group 414a-414c, 424a-1 through 424a-n. This is not to say that there is absolutely no contact among any of the first intermittent swage boss structures 414a-, 414b, 414c, 424a-1 through 424a-n and the second intermittent swage boss structures 414d, 414e, 414f, 424b-1 through 424b-n, after swaging, whereby such structures are cold worked to form the inter-coupling of components. Rather, there may be some contact after swaging but such contact would not be expected to interfere with the intended purpose of producing a viable swage coupling or joint. Therefore, a higher retention torque of the swage coupling is expected in comparison with the configuration of swage plate 300 of FIG. 3, even in view of a thinner arm tip and shorter corresponding swaging hole.

### Physical Description of an Illustrative Operating Context

Embodiments may be used in the context of a digital data storage device (DSD) such as a hard disk drive (HDD). Thus, in accordance with an embodiment, a plan view illustrating a conventional HDD 100 is shown in FIG. 1 to aid in describing how a conventional HDD typically operates.

FIG. 1 illustrates the functional arrangement of components of the HDD 100 including a slider 110b that includes a magnetic read-write head 110a. Collectively, slider 110b and head 110a may be referred to as a head slider. The HDD 100 includes at least one head gimbal assembly (HGA) 110 including the head slider, a lead suspension 110c attached to the head slider typically via a flexure, and a load beam 110d attached to the lead suspension 110c. The HDD 100 also includes at least one recording medium 120 rotatably mounted on a spindle 124 and a drive motor (not visible) attached to the spindle 124 for rotating the medium 120. The read-write head 110a, which may also be referred to as a transducer, includes a write element and a read element for respectively writing and reading information stored on the medium 120 of the HDD 100. The medium 120 or a plurality of disk media may be affixed to the spindle 124 with a disk clamp 128.

The HDD 100 further includes an arm 132 attached to the HGA 110, a carriage 134, a voice-coil motor (VCM) that includes an armature 136 including a voice coil 140 attached to the carriage 134 and a stator 144 including a voice-coil magnet (not visible). The armature 136 of the VCM is attached to the carriage 134 and is configured to move the arm 132 and the HGA 110 to access portions of the medium 120, all collectively mounted on a pivot shaft 148 with an interposed pivot bearing assembly 152. In the case of an HDD having multiple disks, the carriage 134 may be referred to as an “E-block,” or comb, because the carriage is arranged to carry a ganged array of arms that gives it the appearance of a comb.

An assembly comprising a head gimbal assembly (e.g., HGA 110) including a flexure to which the head slider is coupled, an actuator arm (e.g., arm 132) and/or load beam to which the flexure is coupled, and an actuator (e.g., the VCM) to which the actuator arm is coupled, may be collectively referred to as a head-stack assembly (HSA). An HSA may, however, include more or fewer components than those described. For example, an HSA may refer to an assembly that further includes electrical interconnection components. Generally, an HSA is the assembly configured to move the head slider to access portions of the medium 120 for read and write operations.

With further reference to FIG. 1, electrical signals (e.g., current to the voice coil 140 of the VCM) comprising a write signal to and a read signal from the head 110a, are transmitted by a flexible cable assembly (FCA) 156 (or “flex cable”, or “flexible printed circuit” (FPC)). Interconnection between the flex cable 156 and the head 110a may include an arm-electronics (AE) module 160, which may have an on-board pre-amplifier for the read signal, as well as other read-channel and write-channel electronic components. The AE module 160 may be attached to the carriage 134 as shown. The flex cable 156 may be coupled to an electrical-connector block 164, which provides electrical communication, in some configurations, through an electrical feed-through provided by an HDD housing 168. The HDD housing 168 (or “enclosure base” or “baseplate” or simply “base”), in conjunction with an HDD cover, provides a semi-sealed (or hermetically sealed, in some configurations) protective enclosure for the information storage components of the HDD 100.

Other electronic components, including a disk controller and servo electronics including a digital-signal processor (DSP), provide electrical signals to the drive motor, the voice coil 140 of the VCM and the head 110a of the HGA 110. The electrical signal provided to the drive motor enables the drive motor to spin providing a torque to the spindle 124 which is in turn transmitted to the medium 120 that is affixed to the spindle 124. As a result, the medium 120 spins in a direction 172. The spinning medium 120 creates a cushion of air that acts as an air-bearing on which the air-bearing surface (ABS) of the slider 110b rides so that the slider 110b flies above the surface of the medium 120 without making contact with a thin magnetic-recording layer in which information is recorded. Similarly in an HDD in which a lighter-than-air gas is utilized, such as helium for a non-limiting example, the spinning medium 120 creates a cushion of gas that acts as a gas or fluid bearing on which the slider 110b rides.

The electrical signal provided to the voice coil 140 of the VCM enables the head 110a of the HGA 110 to access a track 176 on which information is recorded. Thus, the armature 136 of the VCM swings through an arc 180, which enables the head 110a of the HGA 110 to access various tracks on the medium 120. Information is stored on the medium 120 in a plurality of radially nested tracks arranged in sectors on the medium 120, such as sector 184. Correspondingly, each track is composed of a plurality of sectored track portions (or “track sector”) such as sectored track portion 188. Each sectored track portion 188 may include recorded information, and a header containing error correction code information and a servo-burst-signal pattern, such as an ABCD-servo-burst-signal pattern, which is information that identifies the track 176. In accessing the track 176, the read element of the head 110a of the HGA 110 reads the servo-burst-signal pattern, which provides a position-error-signal (PES) to the servo electronics, which controls the electrical signal provided to the voice coil 140 of the VCM, thereby enabling the head 110a to follow the track 176. Upon finding the track 176 and identifying a particular sectored track portion 188, the head 110a either reads information from the track 176 or writes information to the track 176 depending on instructions received by the disk controller from an external agent, for example, a microprocessor of a computer system.

An HDD's electronic architecture comprises numerous electronic components for performing their respective functions for operation of an HDD, such as a hard disk controller (“HDC”), an interface controller, an arm electronics module, a data channel, a motor driver, a servo processor, buffer memory, etc. Two or more of such components may be combined on a single integrated circuit board referred to as a “system on a chip” (“SOC”). Several, if not all, of such electronic components are typically arranged on a printed circuit board that is coupled to the bottom side of an HDD, such as to HDD housing 168.

References herein to a hard disk drive, such as HDD 100 illustrated and described in reference to FIG. 1, may encompass an information storage device that is at times referred to as a “hybrid drive”. A hybrid drive refers generally to a storage device having functionality of both a traditional HDD (see, e.g., HDD 100) combined with solid-state storage device (SSD) using non-volatile memory, such as flash or other solid-state (e.g., integrated circuits) memory, which is electrically erasable and programmable. As operation, management and control of the different types of storage media typically differ, the solid-state portion of a hybrid drive may include its own corresponding controller functionality, which may be integrated into a single controller along with the HDD functionality. A hybrid drive may be architected and configured to operate and to utilize the solid-state portion in a number of ways, such as, for non-limiting examples, by using the solid-state memory as cache memory, for storing frequently-accessed data, for storing I/O intensive data, and the like. Further, a hybrid drive may be architected and configured essentially as two storage devices in a single enclosure, i.e., a traditional HDD and an SSD, with either one or multiple interfaces for host connection.

### Extensions and Alternatives

In the foregoing description, embodiments of the invention have been described with reference to numerous specific details that may vary from implementation to implementation. Therefore, various modifications and changes may be made thereto without departing from the broader spirit and scope of the embodiments. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

In addition, in this description certain process steps may be set forth in a particular order, and alphabetic and alphanumeric labels may be used to identify certain steps. Unless specifically stated in the description, embodiments are not necessarily limited to any particular order of carrying out such steps. In particular, the labels are used merely for convenient identification of steps, and are not intended to specify or require a particular order of carrying out such steps.

1. A head gimbal assembly (HGA) comprising:
an arm comprising a swaging hole;
a first suspension assembly;
a first swage plate to which the first suspension assembly is coupled, the first swage plate swage-coupling the first suspension assembly to a first side of the arm and comprising a first series of intermittent swage boss structures extending from a first baseplate around a through-hole in the first baseplate;
a second suspension assembly; and
a second swage plate to which the second suspension assembly is coupled, the second swage plate swage-coupling the second suspension assembly to a second opposing side of the arm and comprising a second series of intermittent swage boss structures extending from a second baseplate around a through-hole in the second baseplate;
wherein each swage boss structure of the first series of intermittent swage boss structures is positioned between adjacent swage boss structures of the second series of intermittent swage boss structures.

2. The HGA of claim 1, wherein:
the first swage plate couples the first suspension assembly to the first side of the arm via the first series of intermittent swage boss structures extending in one direction into the swaging hole of the arm; and
the second swage plate couples the second suspension assembly to the second side of the arm via the second series of intermittent swage boss structures extending in an opposing direction into the swaging hole of the arm, such that the second series of intermittent swage boss structures does not interfere with the first series of intermittent swage boss structures.

3. The HGA of claim 1, wherein a height of the swage boss structures of the first series of intermittent swage boss structures, extending in one direction into the swaging hole of the arm, is substantially equal to a height of the swage boss structures of the second series of intermittent swage boss structures, extending in an opposing direction into the swaging hole of the arm.

4. The HGA of claim 1, wherein the swage boss structures of the first series of intermittent swage boss structures are equidistant.

5. The HGA of claim 1, wherein the swage boss structures of the first series of intermittent swage boss structures are not equidistant.

6. The HGA of claim 1, wherein each of the swage boss structures of the first series of intermittent swage boss structures is of substantially equal circumferential span.

7. The HGA of claim 1, wherein at least two of the swage boss structures of the first series of intermittent swage boss structures are of unequal circumferential span.

8. A hard disk drive comprising the HGA of claim 1.

9. A hard disk drive (HDD) comprising:
a plurality of recording disk media rotatably mounted on a spindle;
means for writing to and reading from a first recording disk medium of the plurality of recording disk media;
a voice coil actuator configured to move the means for writing and reading to access portions of the first recording disk medium; and
a head gimbal assembly (HGA) coupled with the voice coil actuator, the HGA comprising:
a carriage arm comprising a swaging hole,
a first suspension assembly comprising a load beam and a flexure,
a first swage plate to which the first suspension assembly is coupled, the first swage plate swage-coupling the first suspension assembly to a first side of the carriage arm and comprising a first series of intermittent swage boss structures extending from a first baseplate around a through-hole in the first baseplate,
a second suspension assembly comprising a second load beam and a second flexure, and
a second swage plate to which the second suspension assembly is coupled, the second swage plate swage-coupling the second suspension assembly to a second side of the carriage arm and comprising a second series of intermittent swage boss structures extending from a second baseplate around a through-hole in the second baseplate;
wherein each swage boss structure of the first series of intermittent swage boss structures is positioned between adjacent swage boss structures of the second series of intermittent swage boss structures.

10. The HDD of claim 9, wherein:
the first swage plate of the HGA couples the first suspension assembly to the first side of the carriage arm via the first series of intermittent swage boss structures extending in one direction into the swaging hole of the carriage arm; and
the second swage plate of the HGA couples the second suspension assembly to the second side of the carriage arm via the second series of intermittent swage boss structures extending in an opposing direction into the swaging hole of the carriage arm, such that the second series of intermittent swage boss structures does not interfere with the first series of intermittent swage boss structures.

11. The HDD of claim 9, wherein a height of the swage boss structures of the first series of intermittent swage boss structures, extending in one direction into the swaging hole of the carriage arm, is substantially equal to a height of the swage boss structures of the second series of intermittent swage boss structures, extending in an opposing direction into the swaging hole of the carriage arm.

12. The HDD of claim 9, wherein the swage boss structures of the first series of intermittent swage boss structures of the HGA are equidistant.

13. The HDD of claim 9, wherein the swage boss structures of the first series of intermittent swage boss structures of the HGA are not equidistant.

14. A method of assembling a head gimbal assembly (HGA), the method comprising:
swaging a first suspension to a first side of an actuator arm via a first interpose swage boss of a first swage plate, wherein the first interpose swage boss comprises a first intermittent group of extending swage boss structures extending around a through-hole in the first swage plate; and
swaging a second suspension to an opposing second side of the actuator arm via a second interpose swage boss of a second swage plate, wherein the second interpose swage boss comprises a second intermittent group of extending swage boss structures extending around a through-hole in the second swage plate.

15. The method of claim 14, wherein:
swaging the first suspension includes swaging via the first interpose swage boss such that each extending swage boss structure of the first intermittent group is positioned between adjacent extending swage boss structures of the second intermittent group.

16. The method of claim 15, wherein:
swaging the second suspension includes swaging via the second interpose swage boss such that each extending swage boss structure of the second intermittent group is positioned between adjacent extending swage boss structures of the first intermittent group.

17. The method of claim 16, wherein:
swaging the first suspension includes swaging the first intermittent group of extending swage boss structures extending in one direction from the first side into a swaging hole of the actuator arm; and
swaging the second suspension includes swaging the second intermittent group of extending swage boss structures extending in an opposing direction from the second side into the swaging hole of the actuator arm, such that the second intermittent group does not interfere with the first intermittent group.

18. The HDD of claim 9, wherein each of the swage boss structures of the first series of intermittent swage boss structures is of substantially equal circumferential span.

19. The HDD of claim 9, wherein at least two of the swage boss structures of the first series of intermittent swage boss structures are of unequal circumferential span.

20. The method of claim 14, wherein:
the swage boss structures of the first intermittent group of extending swage boss structures are equidistant; and
each of the swage boss structures of the first intermittent group of extending swage boss structures is of substantially equal circumferential span.
